(19) United States
(12) Patent Application Publication
(10) Pub. No.: US 2026/0118505 A1
(43) Pub. Date: Apr. 30, 2026

(54) GROUND/WEATHER DIFFERENTIATION USING MONOPULSE

(71) Applicant: Rockwell Collins, Inc., Cedar Rapids, IA (US)

(72) Inventors: Venkata A. Sishtla, Cedar Rapids, IA (US); Mark C. Fersdahl, Cedar Rapids, IA (US); Xingming Wang, Marion, IA (US)

(21) Appl. No.: 18/926,815

(22) Filed: Oct. 25, 2024

(51) Int. Cl. G01S 13/95

(52) U.S. Cl. CPC G01S 13/953

(57) ABSTRACT

A radar system may generate weather data using a monopulse technique. Monopulse may divide antennas into halves, enabling a comparison between the halves using a single scan compared to multiple scans. The comparison can be used to estimate the angle of arrival for a given target. The angle of arrival can be compared to a theoretical model to make weather clutter decision, using only one scan. This method eliminates target scintillation by removing the time lag that is present while performing sequential operation thereby reducing the amount of temporal filtering. This greatly enhances weather detection performance while also allowing the radar to perform additional functions. Using monopulse, as opposed to traditional radar systems, may reduce the number of scans in half thereby allowing the radar system to perform other autonomy related functions.

### TECHNICAL FIELD

The present disclosure generally relates to radio direction-finding, and more specifically to discriminating targets with respect to background clutter.

### BACKGROUND

Ground clutter suppression (GCS) may be a goal of many Airborne Weather Radar (WxR) systems. Ground clutter may include unwanted ground echoes and unwanted ground signals. Weather radars perform ground clutter suppression by utilizing data from multiple scans of the environment at different elevations. The time delay between these sequential scans will cause noise and target scintillation that results in excessive ground clutter and other noise on the display. Adequately filtering the data can reduce this noise but will cause delays in weather detection. There is a need for a system that balances temporal filtering and appropriate weather detection. The traditional radar systems may also expend valuable time within the radar's pulse epoch that could be used for additional radar functions. Therefore, it would be advantageous to provide a device, system, and method that cures the shortcomings described above.

### SUMMARY

In some aspects, the techniques described herein relate to a radar system including: a scanned array including a plurality of subarrays, wherein the plurality of subarrays include an upper half of subarrays and a lower half of subarrays; and a controller including one or more processors configured to execute program instructions maintained in memory causing the controller to: configure the scanned array to transmit one or more radar transmission signals; configure the scanned array to receive one or more upper radar return signals and one or more lower radar return signals in response to transmitting the one or more radar transmission signals, wherein the one or more upper radar return signals are received by the upper half of subarrays, wherein the one or more lower radar return signals are received by the lower half of subarrays, wherein the one or more upper radar return signals and the one or more lower radar return signals are received out-of-phase; receive in-phase and quadrature components of the one or more upper radar return signals and the one or more lower radar return signals from the scanned array; and perform a monopulse function using the one or more upper radar return signals and the one or more lower radar return signals to distinguish between a ground target and a weather target in the one or more upper radar return signals and the one or more lower radar return signals.

In some aspects, the techniques described herein relate to a radar system, wherein the plurality of subarrays are at least a two-by-two array.

In some aspects, the techniques described herein relate to a radar system, wherein the scanned array transmits the one or more radar transmission signals and receives the one or more upper radar return signals and the one or more lower radar return signals in a pulse epoch.

In some aspects, the techniques described herein relate to a radar system, wherein the scanned array transmits the one or more radar transmission signals and receives the one or more upper radar return signals and the one or more lower radar return signals at a boresight angle in the pulse epoch.

In some aspects, the techniques described herein relate to a radar system, wherein the controller is configured to determine a sum beam and a difference beam from the one or more upper radar return signals and the one or more lower radar return signals.

In some aspects, the techniques described herein relate to a radar system, wherein the sum beam is a sum of the one or more upper radar return signals and the one or more lower radar return signals.

In some aspects, the techniques described herein relate to a radar system, wherein the difference beam is a difference of the one or more upper radar return signals and the one or more lower radar return signals.

In some aspects, the techniques described herein relate to a radar system, wherein the difference beam is an elevation difference beam.

In some aspects, the techniques described herein relate to a radar system, wherein the controller is configured to determine a monopulse ratio from the sum beam and the difference beam.

In some aspects, the techniques described herein relate to a radar system, wherein the monopulse ratio is the difference beam divided by the sum beam.

In some aspects, the techniques described herein relate to a radar system, wherein the controller is configured to determine an angle-to-target from the monopulse ratio.

In some aspects, the techniques described herein relate to a radar system, wherein the controller is configured to compare the angle-to-target with a threshold to determine if the angle-to-target is below the threshold and therefore ground clutter from the ground target or above the threshold and therefore the weather target.

In some aspects, the techniques described herein relate to a radar system, wherein the controller is configured to suppress the one or more upper radar return signals and the one or more lower radar return signals in which the angle-to-target is below the threshold as ground clutter from the ground target.

In some aspects, the techniques described herein relate to a radar system, wherein the controller is configured to compute the threshold.

In some aspects, the techniques described herein relate to a radar system, wherein the controller is configured to compute the threshold based on at least a range from the scanned array to the ground target.

In some aspects, the techniques described herein relate to a radar system, wherein the controller is configured to cause a flight display to display the weather target.

In some aspects, the techniques described herein relate to a radar system, wherein the radar system is configured to perform multiple radar sweeps of a radar beam, wherein the radar beam includes the one or more radar transmission signals, the one or more upper radar return signals and the one or more lower radar return signals, wherein the radar system is configured to sweep the radar beam in azimuth and elevation, wherein the scanned array is one of an active electronically scanned array or a mechanically scanned array.

In some aspects, the techniques described herein relate to a radar system, wherein the one or more radar transmission signals reflect from at least one of the ground target and the weather target and return as the one or more upper radar return signals and the one or more lower radar return signals.

In some aspects, the techniques described herein relate to a radar system, wherein the monopulse function is one of a phase-comparison monopulse function or an amplitude-comparison monopulse function.

In some aspects, the techniques described herein related to a method including: configuring a scanned array to transmit one or more radar transmission signals, wherein the scanned array comprises a plurality of subarrays, wherein the plurality of subarrays include an upper half of subarrays and a lower half of subarrays; configuring the scanned array to receive one or more upper radar return signals and one or more lower radar return signals in response to transmitting the one or more radar transmission signals, wherein the one or more upper radar return signals are received by the upper half of subarrays, wherein the one or more lower radar return signals are received by the lower half of subarrays, wherein the one or more upper radar return signals and the one or more lower radar return signals are received out-of-phase; receiving in-phase and quadrature components of the one or more upper radar return signals and the one or more lower radar return signals from the scanned array; and performing a monopulse function using the one or more upper radar return signals and the one or more lower radar return signals to distinguish between a ground target and a weather target in the one or more upper radar return signals and the one or more lower radar return signals.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A depicts a cockpit of an aircraft, in accordance with one or more embodiments of the present disclosure.

FIG. 1B depicts the aircraft with a radar system, in accordance with one or more embodiments of the present disclosure.

FIG. 2 depicts a simplified block diagram of the radar system, in accordance with one or more embodiments of the present disclosure.

FIGS. 3A-3B depict the radar system transmitting and receiving signals, in accordance with one or more embodiments of the present disclosure.

FIG. 4 depicts graphs of angle-to-target as a function of range bins for detecting weather above a threshold, in accordance with one or more embodiments of the present disclosure.

FIG. 5 depicts a flow diagram of a method, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are directed to ground/weather differentiation using monopulse. A radar system may generate weather data using a monopulse technique. Monopulse may divide antennas into halves, enabling a comparison between the halves using a single scan compared to multiple scans. The comparison can be used to estimate the angle of arrival for a given target. The angle of arrival can be compared to a theoretical model to make weather clutter decision, using only one scan. This method eliminates target scintillation by removing the time lag that is present while performing sequential operation thereby reducing the amount of temporal filtering. This greatly enhances weather detection performance while also allowing the radar to perform additional functions. Using monopulse, as opposed to traditional radar systems, may reduce the number of scans in half thereby allowing the radar system to perform other autonomy related functions.

U.S. Patent Publication Number US20240142574A1, titled “Hybrid clutter suppression using electronically scanned antennas”; U.S. Patent Publication Number US20230222922A1, titled “Optimized weather and threat depiction based on aircraft flight plan”; U.S. Patent Number U.S. Pat. No. 11,953,617B2, titled “Multi-panel multi-function AESA system”; U.S. Patent Number U.S. Pat. No. 11,754,706B2, titled “Agile antenna taper based on weather radar feedback”; U.S. Patent Number U.S. Pat. No. 11,181,634B1, titled “Systems and methods of intelligent weather sensing using deep learning convolutional neural networks”; U.S. Patent Number U.S. Pat. No. 11,187,800B1, titled “Fusion of horizontal and vertical sweeps for weather detection”; U.S. Patent Number U.S. Pat. No. 9,019,145B1, titled “Ground clutter rejection for weather radar”; U.S. Patent Number U.S. Pat. No. 8,203,480B1, titled “Predictive and adaptive weather radar detection system and method”; U.S. Patent Number U.S. Pat. No. 7,973,698B1, titled “System and method for using a radar to estimate and compensate for atmospheric refraction”; U.S. Patent Number U.S. Pat. No. 7,616,150B1, titled “Null steering system and method for terrain estimation”; U.S. Patent Number U.S. Pat. No. 7,843,380B1, titled “Half aperture antenna resolution system and method”; U.S. Patent Number U.S. Pat. No. 7,733,264B1, titled “System and method for generating weather radar information”; U.S. Patent Number U.S. Pat. No. 11,506,750B2, titled “Time division multiplexed monopulse AESA comparator network”; U.S. Patent Number U.S. Pat. No. 11,156,461B1, titled “System and method for optimizing hold and divert operations”; are incorporated herein by reference in the entirety.

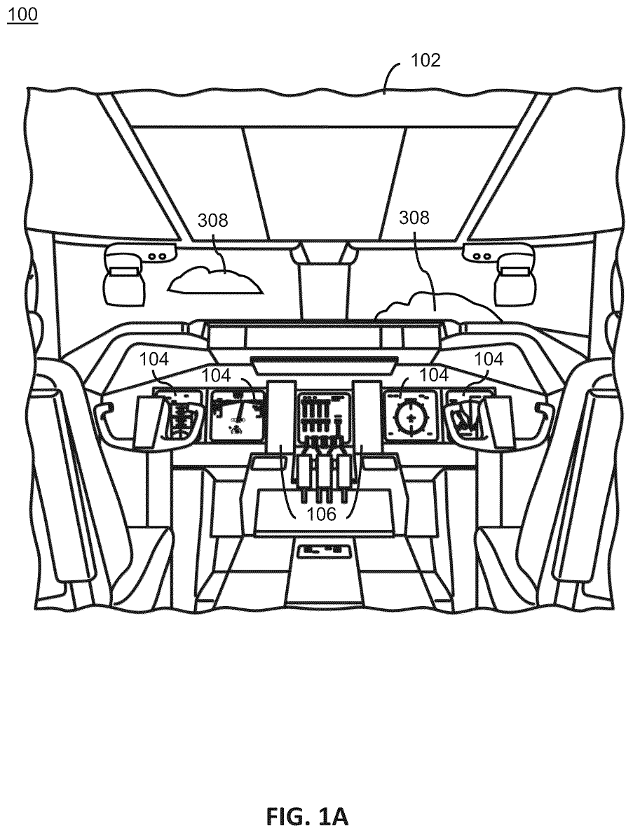

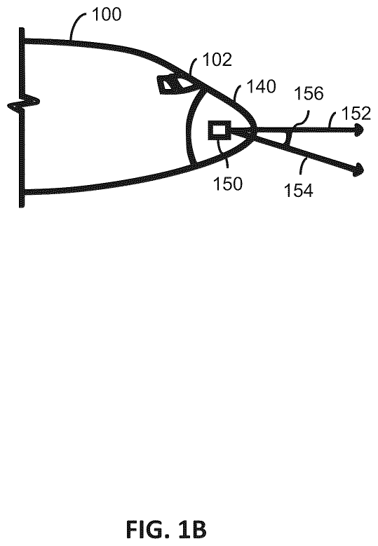

Referring to FIG. 1A, a schematic illustration of a cockpit 102 of an aircraft 100 is shown according to an exemplary embodiment of the inventive concepts disclosed herein. The cockpit 102 may include flight displays 104 and user interface elements (UI elements 106).

The flight displays 104 may be implemented using any of a variety of display technologies, including CRT, LCD, organic LED, dot matrix display, and others. The flight displays 104 may be navigation (NAV) displays, primary flight displays, electronic flight bag displays, tablets, synthetic vision system displays, head up displays (HUDs) with or without a projector, and the like. The flight displays 104 may be used to provide information to the flight crew, thereby increasing visual range and enhancing decision-making abilities. One or more of the flight displays 104 may be configured to function as, for example, a primary flight display (PFD) used to display altitude, airspeed, vertical speed, and navigation and traffic collision avoidance system (TCAS) advisories. One or more of the flight displays 104 may also be configured to function as, for example, a multi-function display used to display navigation maps, weather data, electronic charts, TCAS traffic, aircraft maintenance data and electronic checklists, manuals, and procedures. One or more of the flight displays 104 may also be configured to function as, for example, an engine indicating and crew-alerting system (EICAS) display used to display critical engine and system status data. Other types and functions of the flight displays 104 are contemplated as well. According to various exemplary embodiments of the inventive concepts disclosed herein, at least one of the flight displays 104 may be configured to provide a rendered display from the systems and methods of the present disclosure.

The flight displays 104 may provide an output from an onboard aircraft-based radar system, LIDAR system, infrared system or other system on an aircraft. For example, the flight displays 104 may include a weather display, a weather radar map, and a terrain display. The flight displays 104 may provide an output based on a combination of data received from multiple external systems or from at least one external system and an onboard aircraft-based system. The flight displays 104 may include an electronic display or a synthetic vision system (SVS). For example, the flight displays 104 may include a display configured to display a two-dimensional (2-D) image, a three-dimensional (3-D) perspective image of terrain and/or weather information, or a four-dimensional (4-D) display of weather information or forecast information. Other views of terrain and/or weather information may also be provided (e.g., plan view, horizontal view, vertical view). The views may include monochrome or color graphical representations of the terrain and/or weather information. Graphical representations of weather or terrain may include an indication of altitude of the weather or terrain or the altitude relative to the aircraft.

The flight displays 104 may be a color display providing graphical images in color to represent the severity of the weather. The flight displays 104 may be configured to display weather data in two dimensions and may operate according to ARINC 453 and 708 standards. A horizontal plan view may provide an overview of weather patterns that may affect an aircraft mapped onto a horizontal plane. The horizontal plan view may provide images of weather conditions in the vicinity of the aircraft, such as indications of precipitation rates. Red, yellow, and green colors may be used to represent areas of respective precipitation rates, and black color may represent areas of very little or no precipitation. Each color may be associated with a radar reflectivity range which corresponds to a respective precipitation rate range. Red may indicate the highest rates of precipitation while green may represent the lowest (non-zero) rates of precipitation. The flight displays 104 may also utilize a magenta color to indicate regions of turbulence.

The UI elements 106 may include, for example, dials, switches, buttons, touch screens, keyboards, a mouse, joysticks, cursor control devices (CCDs) or other multi-function key pads certified for use with avionics systems. The UI elements 106 may be configured to, for example, allow an aircraft crew member to interact with various avionics applications and perform functions such as data entry, manipulation of navigation maps, and moving among and selecting checklist items. For example, the UI elements 106 may be used to adjust features of the flight displays 104, such as contrast, brightness, width, and length. The UI elements 106 may also (or alternatively) be used by an aircraft crew member to interface with or manipulate the displays of the flight displays 104. For example, the UI elements 106 may be used by aircraft crew member to adjust the brightness, contrast, and information displayed on the flight displays 104. The UI elements 106 may additionally be used to acknowledge or dismiss an indicator provided by the flight displays 104. The UI elements 106 may be used to correct errors on the flight displays 104. The UI elements 106 may also include indicator lights, displays, display elements, and audio alerting devices. The UI elements 106 may be configured to warn of potentially threatening conditions such as severe weather, terrain, and obstacles, such as potential collisions with other aircraft.

Referring to FIG. 1B, a schematic illustration of the front of an aircraft 100 is shown according to an exemplary embodiment of the inventive concepts disclosed herein. The aircraft 100 includes a nose 140, a radar system 150, and the aircraft control center or cockpit 102.

The radar system 150 may also be referred to as a weather radar, on-board weather radar, and the like. The radar system 150 is generally located inside the nose 140 of the aircraft 100 or inside the cockpit 102 of the aircraft 100. According to other exemplary embodiments of the inventive concepts disclosed herein, the radar system 150 may be located anywhere on the aircraft 100, such as on the top of the aircraft 100, on the belly of the aircraft 100, on the tail of the aircraft 100, or on either or both sides of the aircraft 100. Various components of the radar system 150 may be distributed at multiple locations throughout the aircraft 100. The radar system 150 may include or be coupled to an antenna system of the aircraft 100. The radar system 150 or other equipment onboard the aircraft 100 may be configured to receive radar data from other sources. For example, the radar system 150 or other equipment aboard the aircraft 100 may receive radar data from ground-based radar systems, satellite-based systems, and from aircraft-based system of other aircraft. The radar system 150 may be any radar system configured to detect or receive data for the systems and methods of the present disclosure. The radar system 150 may detect multiple threats areas (e.g., weather cells, traffic, convective weather systems (e.g., thunderstorms), turbulence, winds aloft, icing, hail, or volcanic ash, air targets (e.g., other aircraft), ground targets (e.g., other aircraft on the ground, baggage carts, and the like), terrain, and the like), or similar system.

The radar system 150 may be configured to transmit and/or receive a radar beam. The radar beam may include a beam width. For example, the radar beam may be a pencil beam with a beam width of about four or five degrees.

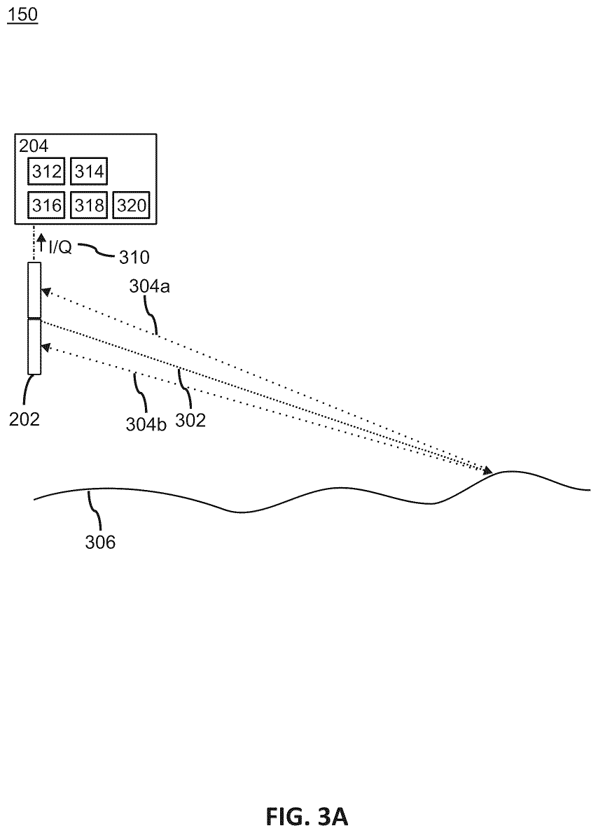

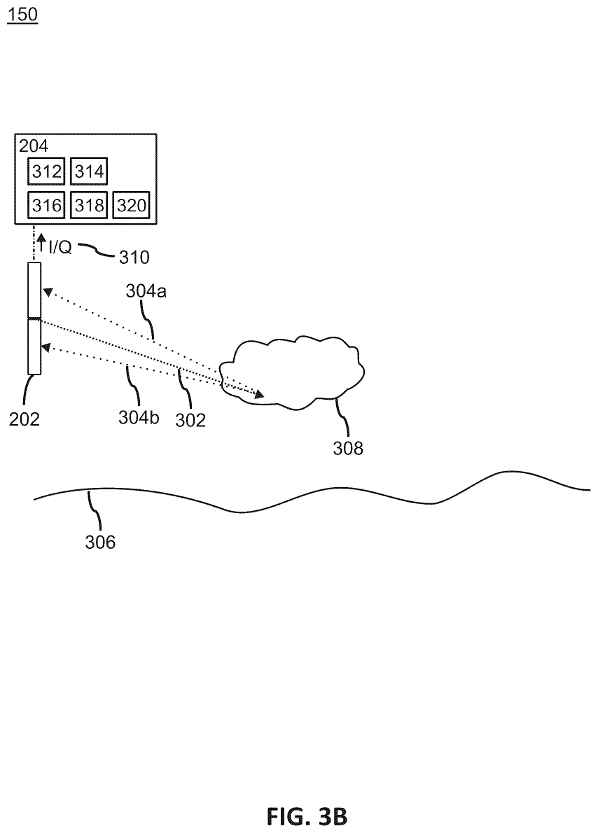

The radar system 150 may perform multiple sweeps of the radar beam. The radar sweeps may include horizontal sweeps, vertical sweeps, or a combination of horizontal and vertical sweeps of the radar transmission signals 302 and the radar return signals 304 from FIGS. 3A and 3B. Sweeps of the radar beam may occur across multiple pulse epochs of the radar beam. The sweeps may also be referred to as scans.

The radar system 150 may sweep the radar beam in azimuth. For example, the radar system 150 may sweep the radar beam horizontally back and forth. In some embodiments, the radar system 150 may sweep a radar beam horizontally and forth at varying azimuth angles. The horizontal sweep may be at one tilt angle over a range of azimuth angles. The radar system 150 may horizontally sweep the radar beams with a wide field of view (FOV), such as more than 30 degrees in azimuth. The radar system 150 may conduct one or more of the horizontal sweeps. For example, the radar system 150 may conduct a first horizontal sweep 152 directly in front of the aircraft 100 and a second horizontal sweep 154 downward at a tilt angle 156 (e.g., up to 20 degrees downward). Returns from the horizontal sweeps at different tilt angles may be electronically merged to form a composite image for display on an electronic display, such as the flight displays 104 in the cockpit 102. Returns may also be processed to, for example, distinguish among terrain, weather, and other objects, to determine the height of the terrain, and/or to determine the height of the weather.

The radar system 150 may also sweep the radar beam in elevation. For example, the radar system 150 may sweep the radar beam vertically back and forth. In some embodiments, the radar system 150 may sweep a radar beam vertically back and forth at varying vertical tilt angles. The vertical sweep may be performed at one azimuth angle over a range of tilt angles. Results from the different vertical tilt angles may be analyzed to determine the characteristics of weather. For example, the altitude, range, and vertical height of weather conditions may be determined using the vertical scan results. The vertical scan results may be used to form an image for display on an electronic display. For example, a vertical profile view of the weather may be generated and provided to flight crew on the flight display 104 of the cockpit 102. The profile may be used by a flight crew to determine height, range, hazards and threats, and other relevant information that may be utilized by an aircraft crew member to evaluate a current course or to change the course of the aircraft to avoid the detected weather condition. The profile may also be used by an autonomous system which determines the height, range, hazards and threats, and other relevant information. The autonomous system may include one or more functions, such as, but not limited to, image processing to determine the height, range, hazards and threats, and other relevant information. The image processing may include an image processing model trained using machine learning or a similar approach.

The radar system 150 may include control settings, such as, but not limited to, range setting, gain setting, mode setting, scan angle setting, tilt setting, GCS setting (ground clutter suppression setting), alert setting, auto/manual setting, and the like. The range setting may indicate the maximum range of the weather radials. The range setting may also be referred to as an antenna coverage range in the flight path. The gain setting may indicate the sensitivity of the radar system 150. The mode setting may include one or more modes for the radar system 150. The modes may include, but are not limited to, weather mode (WX), turbulence mode (TURB), weather and turbulence mode (WX+T), map mode (MAP), and the like. The scan angle setting may indicate a scan angle of the radar system 150. The scan angle may also be referred to as an antenna coverage value range. The tilt setting may indicate a tilt angle of the radar system 150. The GCS setting may automatically filter out ground clutter when turned on. The alert setting may provide an automatic alert upon detecting a hazardous weather condition. For example, the alert setting may include, but is not limited to, a windshear alert, turbulence alert, and the like. The auto/manual setting may automatically adjust one or more of the range setting, the gain setting, the mode setting, the tilt setting, and/or the GCS setting when set to auto. The various settings may be automatically adjusted based on avionics data. The avionics data used to adjust the various settings may include, but is not limited to, altitude, temperature, global position, time, phase-of-flight, and the like.

The radar system 150 may generate radar data based on the return of the radar beam. The radar data may include, but is not limited to, ARINC 708 data, Avionics Full-Duplex Switched Ethernet (AFDX) ARINC 664 data, and the like. The ARINC 708 data may include, but is not limited to ARINC 708A data. The ARINC 708A data may include, but is not limited to, Display Mode, Gain, Tilt, Scan angle, Range, weather conditions, and/or weather alerts. The radar data may include Range Bin data (e.g., reflectivity value in terms of color coding), weather alerts (e.g., Windshear Alert, Turbulence Alert, etc.), and the like. The radar data may also be indicative of one or more types of weather conditions. For example, the radar data may be indicative of threat areas such as, but not limited to, weather cells, convective weather systems (e.g., thunderstorms), turbulence, winds aloft, icing, hail, volcanic ash, traffic, terrain, air targets (e.g., other aircraft), ground targets (e.g., other aircraft on the ground, baggage carts, and the like), terrain, and the like. Individual weather cells may be, for example, 3-D regions of significant reflectivity or other values above one or more specified threshold values. Individual weather cells may be composed of reflectivity radial run segments, and in turn, 2-D weather components composed of segment groups and occurring at different radar elevation angles. Such weather cell data may also include individual data points and trends for each weather cell. For example, current weather cell location may be provided with azimuth, range, direction, and speed information, such as a motion vector using polar and/or Cartesian coordinates along with an estimate of any tracking errors. Other information may be included such as, for example, storm base height, storm top height, maximum reflectivity, height of maximum reflectivity, probability of hail, probability of severe hail, cell-based vertically integrated liquid (VIL) content, enhanced echo tops (EET) and centroid height, among other information types.

The radar data may include data for one or more range bins. Each range bin may include a power value. The power value may be the echo strength returned to the radar system 150. The radar data include power values associated with a threat area including at least one of icing, turbulence, dust storms, volcanic ash, tornadoes, hail, air targets (e.g., other aircraft), ground targets (e.g., other aircraft on the ground, baggage carts, and the like), terrain, and the like.

The power values of the radar data may be reflectivity values. The reflectivity value may also be referred to as reflective power, reflectivity, and the like. The reflectivity value may include a base reflectivity value and/or a composite reflectivity value. The reflectivity value may be a measurement of the amount of backscattered energy. The reflectivity may be measured in decibels relative to z (dBz). In this regard, the reflectivity describes the change in power emitted versus the received power value. The power emitted by the radar system 150 may be constant or known such that the received power value and the reflectivity value is related to the intensity of the weather threat. The reflectivity value may be determined based on the various control settings of the radar system 150, such as, but not limited to, the range setting, the scan angle setting, and the like. The number of the range bins may indicate a resolution of the radar data. Each range bin may also include a position associated with the reflectivity data. The range bins may also be referred to as range gates. The radar data may include raw reflectivity data, ARINC 453 data, or the like. The reflectivity value may be determined based on a size of precipitation particles, a precipitation state, a concentration of precipitation, a shape of the precipitation, and the like.

The radar data may include the power values for the range bins in polar coordinates. The position of each range bin may be defined in polar coordinates (e.g., r, θ) and/or cartesian coordinates (e.g., x, y). In some embodiments, the coordinates are relative to the aircraft 100 (e.g., relative to the radar system 150). In some embodiments, the coordinates are relative to a geographic coordinate system (e.g., latitude and longitude). In this regard, the radar system 150 may perform a transformation method to transform the radar data to define the reflectivity values relative to the geographic coordinate system (e.g., latitude and longitude).

The radar system 150 may be configured to scan a surrounding environment of the aircraft 100 and generate an alert of hazards (e.g., weather patterns or traffic) in the area near the aircraft 100. The radar system 150 may be a weather radar configured to detect weather patterns. The radar system 150 may be a system for detecting weather patterns. Detected weather patterns may be communicated to the flight display 104 for display to the flight crew within the cockpit 102. Detected weather patterns may be used for further processing and analysis, for use in automated functions, or for transmission to an external system via a communication system.

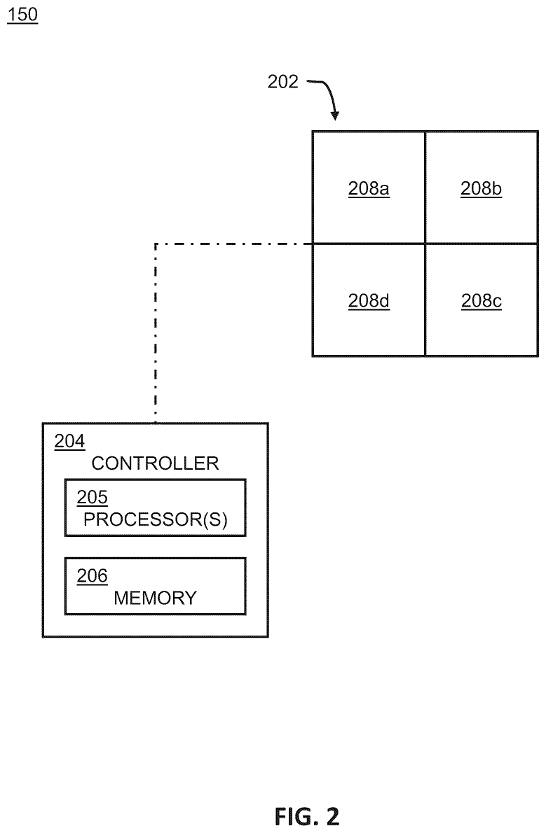

FIG. 2 depicts the radar system 150, in accordance with one or more embodiments of the present disclosure. The radar system 150 may include a scanned array 202, a controller 204, and the like.

The scanned array 202 may be configured to sweep the radar beam of the radar system 150. The scanned array 202 may include any scanned array to sweep the radar beam, such as, but not limited to, an active electronically scanned array (AESA) or a mechanically scanned array. The AESA may scan the boresight angle in elevation and azimuth relative to the antenna axis. The boresight angle and the antenna axis may be coincident where the scanned array 202 is the mechanically scanned array. The mechanically scanned array may then move the antenna axis and the boresight angle to perform the scanning.

The scanned array 202 may define subarrays 208. Each of the subarrays 208 may be separately addressable/configurable by the controller 204 via signals that configure the phase shift and amplitude of the radiating elements within the subarrays 208. The subarrays 208 may be directly or indirectly connected to the controller 204. The subarrays 208 may be connected to the controller 204 in any suitable network topology, such as, but not limited to, a ring, a bus, or the like. For example, the subarrays 208 may be connected to the controller 204 by point-to-point serial peripheral interfaces (SPI) buses.

The scanned array 202 may define at least two of the subarrays 208. The subarrays may be periodic along one or more rows and/or along one or more columns of the scanned array 202. The subarrays 208 may be arranged in a lattice. For example, the subarrays 208 may be arranged in a square lattice to maintain a half-wavelength spacing between adjacent radiating elements. The lattice may include rows and columns of the subarrays 208. The rows of the subarrays 208 may be along the horizontal. The columns of the subarrays 208 may be along the vertical. The rows and columns of the subarrays 208 may be spaced apart at equal distances where the lattice is the square lattice.

Different numbers of the subarrays 208 are envisioned, such as, but not limited to, a two-by-two array, a three-by-three array, a four-by-four array, a sixteen-by-sixteen array, a sixty-four-by-sixty-four array, or the like. For example, the scanned array 202 may be the four-quadrant array defining a first subarray 208a, a second subarray 208b, a third subarray 208c, and a fourth subarray 208d. The number of the subarrays 208 of the scanned array 202 may be flexible and may depend on the ultimate application.

The scanned array 202 may include an upper half of the subarrays 208 and a lower half of the subarrays 208. For example, the first subarray 208a and the second subarray 208b may be the upper half of the subarrays 208, while the third subarray 208c and the fourth subarray 208d may be the lower half of the subarrays 208, where the scanned array 202 is the four-quadrant array.

The subarrays 208 may include a plurality of radiating elements (not depicted). Individual of the radiating elements within the subarrays 208 may or may not be individually addressable. For example, the subarrays 208 may include one or more radio frequency integrated circuits (RFIC) (not depicted). Each of the radio frequency integrated circuits may include a two-by-two array of transmit/receive (T/R) modules. The transmit/receive modules may each include one or more radiating elements. The radiating elements may transmit and receive the radio frequency (RF) signals. The transmit/receive modules may control the power, frequency, phase, time delay, and the like of the radiating elements. The transmit/receive modules may also switch the radiating elements between transmitting and receiving the signals. Thus, each of the radiating elements in the subarrays 208 may be individually addressable from the controller 204 via the transmit/receive modules.

The controller 204 may include processors 205 and memory 206. The processors 205 may be configured to execute program instructions maintained in a memory 206 causing the controller to perform one or more methods of the present disclosure. For example, the controller 204 may configure the scanned array 202 to transmit and/or receive the signals. The controller 204 may also process the signals, as will be described further herein.

The processors may include any one or more processing elements known in the art. In this sense, the one or more processors may include any microprocessor-type device configured to execute software algorithms and/or instructions. In one embodiment, the one or more processors may include a desktop computer, mainframe computer system, workstation, image computer, parallel processor, or other computer system (e.g., networked computer) configured to execute a program configured to operate the system, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors. In general, the term “processor” may be broadly defined to encompass any device having one or more processing elements, which execute program instructions from memory. Moreover, different subsystems of the system (e.g., controller) may include processor or logic elements suitable for carrying out at least a portion of the steps described throughout the present disclosure. Therefore, the above description should not be interpreted as a limitation on the present disclosure but merely an illustration.

The memory may include any storage medium known in the art suitable for storing program instructions executable by the associated one or more processors and the data received. For example, the memory may include a non-transitory memory medium. For instance, the memory may include, but is not limited to, a read-only memory (ROM), a random-access memory (RAM), a magnetic or optical memory device (e.g., disk), a magnetic tape, a solid-state drive and the like. In another embodiment, the memory is configured to store data. It is further noted that memory may be housed in a common controller housing with the one or more processors. In an alternative embodiment, the memory may be located remotely with respect to the physical location of the processors, controller, and the like. In another embodiment, the memory maintains program instructions for causing the one or more processors to carry out the various steps described through the present disclosure.

FIGS. 3A-3B depict the radar system 150, in accordance with one or more embodiments of the present disclosure. The radar beam may include radar transmission signals 302 and radar return signals 304. The scanned array 202 of the radar system 150 may be configured to transmit the radar transmission signals 302 and receive the radar return signals 304. The signals may also be referred to as beams, waves, or the like. The radar beam (e.g., radar transmission signals 302) transmitted by the scanned array 202 may be the sum of the subarrays 208. In this regard, the energy coming out of the subarrays 208 defines the radar beam in the far field of the scanned array 202. The radar beam may reflect and return to the subarrays 208 to be received by the scanned array 202.

The controller 204 may configure the scanned array 202 to transmit the radar transmission signals 302. The controller 204 may also configure the scanned array 202 to receive radar return signals 304 in response to transmitting the radar transmission signals 302. For example, the controller 204 may configure the radar system 150 to transmit the radar transmission signals 302 and to receive radar return signals 304 by controlling the in-phase and quadrature (I/Q) components and/or the amplitude at which the scanned array 202 transmits and receives.

The radar transmission signals 302 and/or the radar return signals 304 may be pulsed. The signals may include any waveform of pulses and dwells. The pulses and dwells may be arranged in a pulse cycle. The signals may include a pulse or a series of pulses at a specific tilt and azimuth angle for the given pulse cycle. The pulses may include a select pulse length and dwell length. The pulse length may be on the order of microseconds or tens of microseconds. The dwell length may be on the order of milliseconds or tens of milliseconds. The radar system 150 may receive the pulses of the radar return signals 304 during the dwells of the radar transmission signals 302. Similarly, the radar system 150 may transmit the pulses of the radar transmission signals 302 during the dwells of the radar return signals 304.

The radar system 150 may transmit the radar transmission signals 302 and/or receive the radar return signals 304 in a pulse epoch (e.g., a monopulse epoch or one pulse epoch). The pulse epoch may be the time at which the radar system 150 transmits and receives the one or more pulses at a given boresight angle. The boresight angle may refer to an angle in elevation and azimuth from an antenna axis of the scanned array 202. The scanned array 202 may transmit the radar transmission signals 302 and receive the radar return signals 304 at the boresight angle in the pulse epoch. The pulse epoch may be on the order of milliseconds or tens of milliseconds. The pulse epoch may depend on the pulse length, the dwell length, and/or the number of pulses in the pulse epoch. The pulse epoch may include one or more of the radar transmission signals 302 and a corresponding number of the radar receive signals 304. For example, the pulse epoch may include four of the radar transmission signals 302. The radar transmission signals 302 in the pulse epoch may or may not include the same pulse length.

The radar transmission signals 302 may include a main lobe. The main lobe may be directed at any angle in azimuth and elevation. The angle of the radar transmission signals 302 in azimuth and elevation may be referred to as the boresight angle. Scanning may refer to changing the angle in azimuth and elevation of the main lobe of the radar transmission signals 302. In the example depicted, the main lobe is directed at a negative angle towards the ground target 306.

The radar transmission signals 302 may reflect from one or more targets and return as the radar return signals 304. For example, the radar transmission signals 302 may reflect from ground target 306 and/or weather target 308 and return as the radar return signals 304. The radar transmission signals 302 may reflect as the radar return signals 304 via scattering, diffusion, or the like. The upper radar return signals 304a and lower radar return signals 304b may be the main lobe of the radar transmission signals 302 reflected from the target. The radar transmission signals 302 and the radar return signals 304 may also include side lobes (not depicted). The main lobes may include a power greater than the side lobes.

The radar return signals 304 may be separated into halves. According to one exemplary embodiment, the radar return signals 304 may be split up into an upper half and a lower half. For example, the radar return signals 304 may include upper radar return signals 304a and lower radar return signals 304b. The controller 204 may configure the scanned array 202 to receive the upper radar return signals 304a and the lower radar return signals 304b.

The upper radar return signals 304a and the lower radar return signals 304b may be received by the upper half and lower half of the subarrays 208, respectively. For example, the upper radar return signals 304a may be received by the first subarray 208a and the second subarray 208b as the upper half of the subarrays 208, while the lower radar return signals 304b may be received by the third subarray 208c and the fourth subarray 208d as the lower half of the subarrays 208, where the scanned array 202 is the four-quadrant array.

The upper radar return signals 304a and lower radar return signals 304b may travel different lengths between reflecting and returning to the scanned array 202. The upper radar return signals 304a may travel a further distance than the lower radar return signals 304b between reflecting and returning to the scanned array 202. The upper radar return signals 304a may travel further because the targets are angled below the scanned array 202. For example, the ground target 306 and the weather target 308 may be generally angled below the scanned array 202. In some instances, the weather target 308 may be angled above the scanned array 202 such that the lower radar return signals 304b may travel a further distance than the upper radar return signals 304a.

The upper radar return signals 304a and lower radar return signals 304b may be received out-of-phase. The length to which the radar return signals 304 travel between reflecting and being received may control in-phase and quadrature components 310 of the radar return signals 304 when received by the scanned array 202. The in-phase and quadrature components 310 may be directly correlated to the length. In this regard, the upper radar return signals 304a and lower radar return signals 304b may be received out-of-phase due to the upper radar return signals 304a and the lower radar return signals 304b travelling different lengths.

The radar return signals 304 may be indicative of weather target 308 and/or ground clutter from the ground target 306. The length which the radar return signals 304 travel and/or the in-phase and quadrature components 310 may depend on whether the radar return signals 304 reflect from the ground target 306 or from the weather target 308. When reflecting from the ground target 306, the lower radar return signals 304b may travel a further distance before being received by the scanned array 202, so that the lower radar return signals 304b is further out-of-phase with the upper radar return signals 304a. When reflecting from the weather target 308, the lower radar return signals 304b and the upper radar return signals 304a may travel a similar length before being received by the scanned array 202, so that the lower radar return signals 304b is nearly in-phase with the upper radar return signals 304a.

The controller 204 may configure the scanned array 202 to measure the radar return signals 304. For example, the scanned array 202 may measure the upper radar return signals 304a and the lower radar return signals 304b. The scanned array 202 may measure the upper radar return signals 304a and the lower radar return signals 304b using the upper half and lower half of the subarrays 208, respectively, of the scanned array 202. For example, the first subarray 208a and the second subarray 208b may measure the upper radar return signals 304a, while the third subarray 208c and the fourth subarray 208d may measure the lower radar return signals 304b, where the scanned array 202 is the four-quadrant array.

The scanned array 202 may measure the radar return signals 304 using any suitable components. For example, the scanned array 202 may measure the radar return signals 304 using analog, digital, and/or hybrid beamforming circuits, RF front ends, time delay units, down converters, phase shifters, splitter/combiners, transmitter/receivers (transceivers), amplifiers, filters, analog-to-digital converters (ADC), and the like. The scanned array 202 may measure the radar return signals 304 for each of the subarrays 208. Alternatively, the scanned array 202 may measure radar return signals 304 for the upper half of the subarrays 208 and the lower half of the subarrays 208 and not measure the radar return signals 304 for each of the subarrays 208 individually.

The scanned array 202 may measure in-phase and quadrature components 310 (I/Q) of the radar return signals 304. The in-phase and quadrature components 310 may include the phase and/or the amplitude of the radar return signals 304. The in-phase and quadrature components 310 may include the phase and/or the amplitude of the upper radar return signals 304a and/or the lower radar return signals 304b. For example, the in-phase and quadrature components 310 may include the phase and/or the amplitude of the upper radar return signals 304a from the sum of the upper halves of the subarrays 208 and/or the phase and/or the amplitude of the lower radar return signals 304b from the sum of the lower halves of the subarrays 208. By way of another example, the in-phase and quadrature components 310 may include the phase and/or the amplitude of the radar return signals 304 from each of the subarrays 208 individually.

The controller 204 may receive the in-phase and quadrature components 310 of the radar return signals 304 from the scanned array 202. The controller 204 may receive the in-phase and quadrature components 310 as a digital signal and/or an analog signal. For example, the controller 204 may include an in-phase and quadrature channel to and/or from each of the subarrays 208. By way of another example, the controller 204 may include an in-phase and quadrature channel to and/or from the upper half of the subarrays 208 and the lower half of the subarrays 208. The in-phase and quadrature channels may be one channel for both transmit and receive or may be a separate channel for transmit and a separate channel for receive.

The controller 204 may be configured to perform a monopulse function using the in-phase and quadrature components 310 of the radar return signals 304 to distinguish between the ground target 306 and the weather target 308 in the radar return signals 304. The monopulse function may include determining a sum beam 312 and/or a difference beam 314 from the radar return signals 304, determine a monopulse ratio 316 from the sum beam 312 and the difference beam 314, determine an angle-to-target 318 from the monopulse ratio 316, and/or distinguish between the ground target 306 and the weather target 308 in the radar return signals 304 using the angle-to-target 318.

The monopulse function may be an amplitude-comparison monopulse function and/or a phase-comparison monopulse function. In embodiments, the controller 204 may be configured to perform the phase-comparison monopulse function.

The controller 204 may be configured to determine the sum beam 312 and/or the difference beam 314 from the radar return signals 304. For example, the controller 204 may determine the sum beam 312 and/or the difference beam 314 from the upper radar return signals 304a and/or the lower radar return signals 304b. The controller 204 may determine the sum beam 312 and/or the difference beam 314 using analog, digital, and/or hybrid signal processing.

The sum beam 312 may be the sum of the radar return signals 304. The sum beam 312 may be the sum of the upper radar return signals 304a received by the upper half of the subarrays the sum of the lower radar return signals 304b received by the lower half of the subarrays 208. For example, the sum beam 312 may be the sum of the upper radar return signals 304a from the first subarray 208a and the second subarray 208b and the sum of the lower radar return signals 304b from the third subarray 208c and the fourth subarray 208d. The sum beam 312 may be determined from both the phase and the amplitude of the radar return signals 304 within the in-phase and quadrature components 310.

The difference beam 314 may be an elevation difference beam. The difference beam 314 may be the difference of the upper radar return signals 304a received by the upper half of the subarrays 208 and the lower radar return signals 304b received by the lower half of the subarrays 208. For example, the difference beam 314 may be the sum of the upper radar return signals 304a from the first subarray 208a and the second subarray 208b minus the sum of the lower radar return signals 304b from the third subarray 208c and the fourth subarray 208d. The difference beam 314 may be determined from both the phase and the amplitude of the radar return signals 304 within the in-phase and quadrature components 310.

The controller 204 may determine the monopulse ratio 316 from the sum beam 312 and the difference beam 314. For example, the monopulse ratio 316 may be the difference beam 314 divided by the sum beam 312. The monopulse ratio 316 may be dimensionless. The monopulse ratio 316 may measure a difference in the phases and/or amplitudes between the sum beam 312 and the difference beam 314.

The controller 204 may determine the angle-to-target 318 from the monopulse ratio 316. The angle-to-target 318 may be the angle of arrival of the radar return signals 304 from the target (e.g., the ground target 306 and/or the weather target 308). The controller 204 may determine the angle-to-target 318 using only one pulse epoch of the radar transmission signals 302. The controller 204 may use a transfer function to determine the angle-to-target 318 from the monopulse ratio 316.

The angle-to-target 318 may indicate the off-boresight angle of the target relative to the boresight of the radar transmission signals 302. The farther the target is from the boresight, the larger the difference in the angle-to-target 318. For the radar return signals 304 from the ground target 306, the angle-to-target 318 may be a function of the altitude of the aircraft 100, physical beam pointing angles, geometry to the ground target 306, and bending of the radar's beam along the path to and from the Earth. This bending, caused by changes in atmospheric density, is known as refraction. For the radar return signals 304 from the ground target 306, the angle-to-target 318 may be a function of the position of the weather target 308.

The controller 204 may distinguish between the ground target 306 and the weather target 308 in the radar return signals 304 using the angle-to-target 318. The controller 204 may compare the angle-to-target 318 with a threshold 320 to determine if the angle-to-target 318 is below the threshold 320 and therefore ground clutter from the ground target 306 or determine the angle-to-target 318 is above the threshold 320 and therefore the weather target 308. The threshold 320 may be a ground clutter suppression (GCS) threshold. The controller 204 may suppress the radar return signals 304 in which the angle-to-target 318 is below the threshold 320 as ground clutter from the ground target 306. If the angle-to-target 318 is below the threshold 320, the radar return signals 304 are reflecting from the ground target 306. For example, if only ground clutter is present in the radar return signals 304, then the angle-to-target 318 looks like the ground clutter is coming from the direction of the ground target 306.

The controller 204 may be configured to cause the flight displays 104 to display the weather target 308 in response to distinguishing between the ground target 306 and the weather target 308 in the radar return signals 304. The controller 204 may cause the flight displays 104 to display the radar return signals 304 in which the angle-to-target 318 is above the threshold 320 as the weather target 308. If the angle-to-target 318 is above the threshold 320, the radar return signals 304 are reflecting from the weather target 308. For example, if returns from the weather target 308 are located above the ground clutter in the radar return signals 304, then the angle-to-target 318 is higher than the direction of the ground target 306 so the radar return signals 304 looks like they are coming from a different location. Thus, the controller 204 may display the weather target 308 and not the ground target 306.

The radar system 150 (e.g., the scanned array 202 and/or the controller 204) may be configured to interpret the radar return signals 304 (e.g., for display by the flight displays 104, for transmission to an external weather system). The radar system 150 may have Doppler capabilities and may measure or detect parameters such as weather range, weather reflectivity, weather velocity, and weather spectral width or velocity variation. The radar system 150 may also detect outside air temperature, winds at altitude, INS G loads (in-situ turbulence), barometric pressure, humidity, and the like.

The controller 204 may utilize the radar return signals 304 received by the scanned array 202 to provide image data indicative of a weather pattern to present on the flight displays 104. The image data may be individual, composite, fused, or overlay image data. The image data may be spatially correlated by the controller 204 using, for example, time of sensing information and motion vector values. In some embodiments, growth and decay information may be accessed, which may be used by the controller 204 to increase or decrease the size, shape, and intensity of an image or other visual indication of a weather condition displayed in accordance with time. In some embodiments, the controller 204 may determine a confidence factor reflecting the degree to which weather data accessed from two or more sources agree in their characterization of the weather pattern. In some embodiments, the controller 204 may combine estimates of storm top height accessed from two or more sources of weather data to provide image data indicative of the vertical extent of a weather pattern.

The controller 204 may also merge or cross qualify portions, or ranges, of the radar return signals 304 of several different antenna sweeps at several different tilt angles, so that a single, relatively clutter-free image may be presented to the pilot based upon the several separate scans. The radar return signals 304 may be processed by the controller 204 to generate a 2-D, 3-D, or 4-D weather profile of the weather near the aircraft 100 (e.g., within about a 100-mile radius of the aircraft 100). In some embodiments, the controller 204 may merge or cross qualify portions, or ranges, of radar returns or weather data of several different sources, including weather data from one or more remote sources via a terrestrial station or communications system, so that a composite or fused image may be presented to the pilot based upon the several weather data sources.

The controller 204 may process the radar return signals 304 to identify or sense the presence of weather conditions in front of (e.g., in the flight path), in view of, or in proximity to the aircraft 100. In some embodiments, the controller 204 may utilize the altitude and range of the weather pattern to generate a vertical profile associated with the weather pattern. The controller 204 may scan across an array of azimuths to generate a 3-D weather profile of the weather near the aircraft 100, which may be stored for later presentation and/or displayed on the flight displays 104. In some embodiments, additional visual indicators other than the representation of weather are provided on the flight displays 104. In some embodiments, a range and bearing matrix having range markers indicating distance from a current location of the aircraft 100 and bearing markers indicating azimuths from a current flight path or bearing of the aircraft 100 may be provided and may assist the pilot in cognitive recognition of weather features from the pilot's perspective.

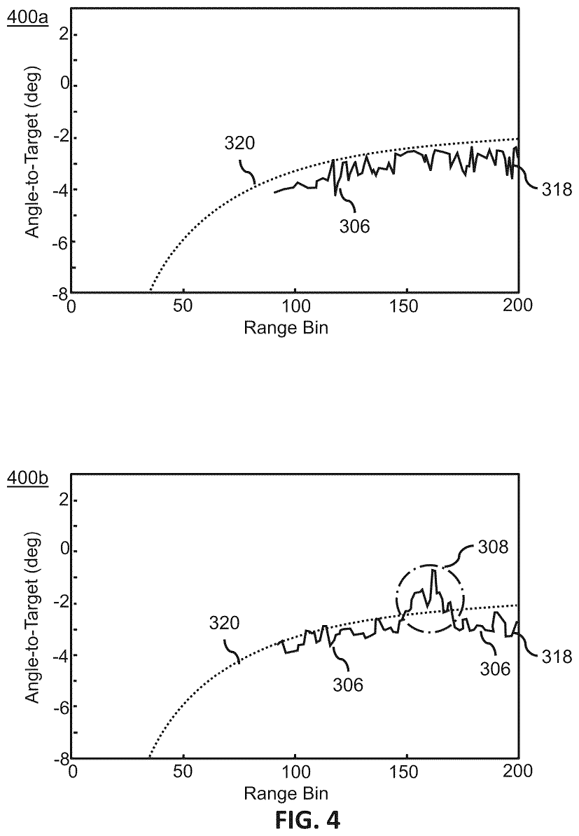

FIG. 4 depicts graphs 400, in accordance with one or more embodiments of the present disclosure. The graphs 400 may include a graph 400a and a graph 400b. The graphs 400 may depict the angle-to-target 318 as a function of the range bins. The range bins may refer to the number of nautical miles in front of the scanned array 202 at which target is located. In this example, the aircraft 100 is at a cruise altitude of 30,000 feet. The range bins are depicted with a range from 0 to 200 nautical miles. The angle-to-target 318 is depicted with a range from −8 to 3 degrees relative to normal axis (e.g., 8 degrees down, 3 degrees up).

The graph 400a is an example where the angle-to-target 318 is determined from the radar return signals 304 reflecting from the ground target 306 without the presence of the weather target 308. In this example, the angle-to-target 318 are below the threshold 320 across the range bins. Thus, the controller 204 has sensed that the weather target 308 is not present in the radar return signals 304. The controller 204 may suppress the radar return signals 304 as ground clutter.

The graph 400b is an example where the angle-to-target 318 is determined from the radar return signals 304 reflecting from the ground target 306 and the weather target 308. In this example, the weather target 308 is in the range bins from about 150 to 175 nautical miles in front of the scanned array 202. In this example, the angle-to-target 318 reflects from the ground target 306 and is below the threshold 320 outside of the range bins in which the weather target 308 is located. Further within this example, the angle-to-target 318 is above the threshold 320 within the range bins in which the weather target 308 is located. Thus, the controller 204 has sensed that the weather target 308 is present in the radar return signals 304 at the range bins from about 150 to 175 nautical miles. The controller 204 may suppress the radar return signals 304 below 150 and 175 nautical miles where the angle-to-target 318 is below the threshold 320 as ground clutter and cause the flight displays 104 to display the radar return signals 304 between 150 and 175 nautical miles in which the angle-to-target 318 is above the threshold 320 as the weather target 308.

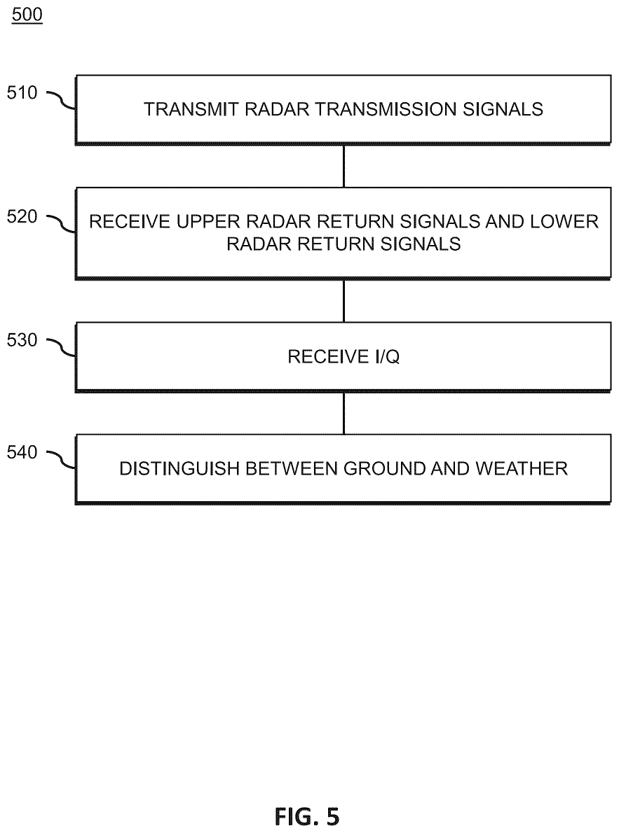

FIG. 5 depicts a flow diagram of a method 500, in accordance with one or more embodiments of the present disclosure. The embodiments and the enabling technologies described previously herein in the context of the aircraft 100, the radar system 150, and/or the controller 204 should be interpreted to extend to the method 500. It is further noted, however, that the method 500 is not limited to the architecture of the aircraft 100, the radar system 150, and/or the controller 204.

In a step 510, the controller 204 may configure the scanned array 202 to transmit one or more of the radar transmission signals 302. The scanned array 202 may include a plurality of the subarrays 208. The plurality of the subarrays 208 may include the upper half of the subarrays 208 and the lower half of the subarrays 208.

in a step 520, the controller 204 may configure the scanned array 202 to receive one or more of the upper radar return signals 304a and one or more of the lower radar return signals 304b in response to transmitting the one or more of the radar transmission signals 302. The one or more of the upper radar return signals 304a may be received by the upper half of the subarrays 208. The one or more of the lower radar return signals 304b may be received by the lower half of the subarrays 208. The one or more of the upper radar return signals 304a and the one or more of the lower radar return signals 304b may be received out-of-phase.

In a step 530, the controller 204 may receive the in-phase and quadrature components 310 of the one or more of the upper radar return signals 304a and the one or more of the lower radar return signals 304b from the scanned array 202.

In a step 540, the controller 204 may perform a monopulse function using the one or more of the upper radar return signals 304a and the one or more of the lower radar return signals 304b to distinguish between the ground target 306 and the weather target 308 in the one or more of the upper radar return signals 304a and the one or more of the lower radar return signals 304b.

Referring generally again to the figures. The radar system 150 may differentiate ground clutter from the weather target 308 using monopulse concepts while minimizing the additional temporal filtering. Using monopulse functions, the radar system 150 may greatly reduce noise due to target scintillation and geographical alignment, as compared to multi-scan techniques. The radar system 150 may also reduce antenna time thereby enabling other functions of the radar system 150.

The controller 204 may be configured to compute the threshold 320. The threshold 320 may be based on the range from the scanned array 202 to the ground target 306. The threshold 320 may be computed based on any of several factors, including but not limited to the location of the aircraft 100, the location of ground clutter, the location of bodies of water, the time-of-day, the time-of-year, and the like. The threshold 320 may be adjusted according to these characteristics using the controller 204. In an exemplary embodiment, location, time, date, and the like may be used to predict ground reflectivity so ground clutter can be suppressed. The threshold 320 may also be a function of time-of-year and time-of-day. As an example of time-of-year adjustments, the controller 204 may consider the changes in ground reflectivity with changes in snow cover and grass cover, seasonal changes in forest foliation and defoliation, and the like. An example of time-of-day adjustment may involve the presence of dew causing increased reflectivity during early morning. The threshold 320 may also be adjusted based on the parameters to support the ground clutter rejection and to optimize weather detection.

Localized threshold optimization methods may be used to improve weather radar ground clutter suppression algorithms. The weather radar may contain a local terrain database which is currently used to determine optimal tilt angle. This database can also be tagged with localized clutter suppression/weather detection threshold information which can be processed to minimize the probability of ground clutter leakage over specific geographical areas.

The controller 204 may determine weather data from the radar return signals 304. The weather data can be based on received horizontal or vertical scans. The weather data can be stored as a mathematical equation representation of the information. The mathematical equation representation may be piecewise linear function, piecewise nonlinear functions, coefficients of a cubic spline, coefficients of a polynomial function, etc. that represent vertical representations of the weather based on the horizontal scan data and/or horizontal representation of the weather based on the vertical scan data. The function may be an equation based on weather parameters that may be sensor driven, model driven, a merger of sensor and model, etc. Although horizontal scan data is described, alternative embodiments may include X, Y Cartesian coordinates, rho/theta input, latitude, and longitude coordinates, etc. Weather may be estimated for any required point in space with the vertical dimension being the subject of the weather equation.

Sensors of the aircraft 100 may include, for example, one or more fuel sensors, airspeed sensors, location tracking sensors (e.g., GPS, etc.), lightning sensors, turbulence sensors, pressure sensors, optical systems (e.g., camera system, infrared system), outside air temperature sensors, winds at altitude sensors, INS G load (in-situ turbulence) sensors, barometric pressure sensors, humidity sensors, or any other aircraft sensors or sensing systems that may be used to monitor the performance of an aircraft or weather local to or remote from the aircraft. Data from the sensors may be output to the controller 204 for further processing and display, or for transmission to a terrestrial station (e.g., a ground-based weather radar system, air traffic control services system, or other terrestrial station) or to other aircraft via a communication system. Data collected from ground-based systems, may also be processed by the controller 204 to configure the collected data for display.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various radar systems by which processes and/or systems and/or other technologies described herein can be affected (e.g., hardware, software, and/or firmware), and that the preferred radar system will vary with the context in which the processes and/or systems and/or other technologies are deployed. For example, if an implementer determines that speed and accuracy are paramount, the implementer may opt for a mainly hardware and/or firmware radar systems; alternatively, if flexibility is paramount, the implementer may opt for a mainly software implementation; or, yet again alternatively, the implementer may opt for some combination of hardware, software, and/or firmware. Hence, there are several possible radar systems by which the processes and/or devices and/or other technologies described herein may be affected, none of which is inherently superior to the other in that any radar system to be utilized is a choice dependent upon the context in which the radar system will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period. For example, the memory may be random access memory (RAM), and the results may not necessarily persist indefinitely in the memory.

It is noted herein that the one or more components of system may be communicatively coupled to the various other components of system in any manner known in the art. For example, the one or more processors may be communicatively coupled to each other and other components via a wireline connection or wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A radar system comprising:
a scanned array comprising a plurality of subarrays, wherein the plurality of subarrays include an upper half of subarrays and a lower half of subarrays; and
a controller comprising one or more processors configured to execute program instructions maintained in memory causing the controller to:
configure the scanned array to transmit one or more radar transmission signals;
configure the scanned array to receive one or more upper radar return signals and one or more lower radar return signals in response to transmitting the one or more radar transmission signals, wherein the one or more upper radar return signals are received by the upper half of subarrays, wherein the one or more lower radar return signals are received by the lower half of subarrays, wherein the one or more upper radar return signals and the one or more lower radar return signals are received out-of-phase;
receive in-phase and quadrature components of the one or more upper radar return signals and the one or more lower radar return signals from the scanned array; and
perform a monopulse function using the one or more upper radar return signals and the one or more lower radar return signals to distinguish between a ground target and a weather target in the one or more upper radar return signals and the one or more lower radar return signals.

2. The radar system of claim 1, wherein the plurality of subarrays are at least a two-by-two array.

3. The radar system of claim 1, wherein the scanned array transmits the one or more radar transmission signals and receives the one or more upper radar return signals and the one or more lower radar return signals in a pulse epoch.

4. The radar system of claim 3, wherein the scanned array transmits the one or more radar transmission signals and receives the one or more upper radar return signals and the one or more lower radar return signals at a boresight angle in the pulse epoch.

5. The radar system of claim 1, wherein the controller is configured to determine a sum beam and a difference beam from the one or more upper radar return signals and the one or more lower radar return signals.

6. The radar system of claim 5, wherein the sum beam is a sum of the one or more upper radar return signals and the one or more lower radar return signals.

7. The radar system of claim 5, wherein the difference beam is a difference of the one or more upper radar return signals and the one or more lower radar return signals.

8. The radar system of claim 7, wherein the difference beam is an elevation difference beam.

9. The radar system of claim 5, wherein the controller is configured to determine a monopulse ratio from the sum beam and the difference beam.

10. The radar system of claim 9, wherein the monopulse ratio is the difference beam divided by the sum beam.

11. The radar system of claim 9, wherein the controller is configured to determine an angle-to-target from the monopulse ratio.

12. The radar system of claim 11, wherein the controller is configured to compare the angle-to-target with a threshold to determine if the angle-to-target is below the threshold and therefore ground clutter from the ground target or above the threshold and therefore the weather target.

13. The radar system of claim 12, wherein the controller is configured to suppress the one or more upper radar return signals and the one or more lower radar return signals in which the angle-to-target is below the threshold as ground clutter from the ground target.

14. The radar system of claim 13, wherein the controller is configured to compute the threshold.

15. The radar system of claim 14, wherein the controller is configured to compute the threshold based on at least a range from the scanned array to the ground target.

16. The radar system of claim 1, wherein the controller is configured to cause a flight display to display the weather target.

17. The radar system of claim 1, wherein the radar system is configured to perform multiple radar sweeps of a radar beam, wherein the radar beam comprises the one or more radar transmission signals, the one or more upper radar return signals and the one or more lower radar return signals, wherein the radar system is configured to sweep the radar beam in azimuth and elevation, wherein the scanned array is one of an active electronically scanned array or a mechanically scanned array.

18. The radar system of claim 1, wherein the one or more radar transmission signals reflect from at least one of the ground target and the weather target and return as the one or more upper radar return signals and the one or more lower radar return signals.

19. The radar system of claim 1, wherein the monopulse function is one of a phase-comparison monopulse function or an amplitude-comparison monopulse function.

20. A method comprising:
configuring a scanned array to transmit one or more radar transmission signals, wherein the scanned array comprises a plurality of subarrays, wherein the plurality of subarrays include an upper half of subarrays and a lower half of subarrays;
configuring the scanned array to receive one or more upper radar return signals and one or more lower radar return signals in response to transmitting the one or more radar transmission signals, wherein the one or more upper radar return signals are received by the upper half of subarrays, wherein the one or more lower radar return signals are received by the lower half of subarrays, wherein the one or more upper radar return signals and the one or more lower radar return signals are received out-of-phase;
receiving in-phase and quadrature components of the one or more upper radar return signals and the one or more lower radar return signals from the scanned array; and
performing a monopulse function using the one or more upper radar return signals and the one or more lower radar return signals to distinguish between a ground target and a weather target in the one or more upper radar return signals and the one or more lower radar return signals.
